(19) United States
(12) Patent Application Publication
(10) Pub. No.: US 2026/0142209 A1
(43) Pub. Date: May 21, 2026

(54) INTEGRATED FUEL REFORMING REACTOR AND FUEL CELL ELECTRICITY GENERATION DEVICE AND METHOD

(71) Applicant: WATT FUEL CELL CORP., Mount Pleasant, PA (US)

(72) Inventors: Caine M. FINNERTY, Mount Pleasant, PA (US); Connor SALLEY, Kittanning, PA (US); Matt ISENBERG, North Canton, OH (US)

(21) Appl. No.: 19/116,557

(22) PCT Filed: Nov. 19, 2024
(86) PCT No.: PCT/US2024/056457

§ 371 Date: Mar. 28, 2025

(51) Int. Cl. H01M 8/0612; H01M 8/04111; H01M 8/0662; H01M 8/12; H01M 8/243

(52) U.S. Cl. CPC H01M 8/0618; H01M 8/04111; H01M 8/0662; H01M 8/243; H01M 2008/1293

(57) ABSTRACT

An integrated fuel reformer/fuel cell electricity generating system that efficiently converts fuel into electricity. A base unit includes an array of CPOX reactor tubes. The base unit can be detachably mated with a fuel cell unit that includes a corresponding array of fuel cells.

When mated, the units form an enclosure. The downstream outlet of the reactor tubes extends through the fuel cells to an upstream end thereof. The base unit blows an air/fuel mixture down the CPOX reactor tubes, which emits a hydrogen rich reformate into an upstream end of the fuel cell. A secondary fuel line can supply secondary fuel which will be steam reformed to additional hydrogen within the fuel cell. An inactive upstream end of the fuel cells can extend outside the enclosure, where it is interconnected with a current collection system maintained at a relatively cool temperature.

### BACKGROUND OF THE INVENTION

The invention relates generally to electricity generating devices that integrate fuel reforming reactors with electricity producing fuel cells.

Fuel cells electrochemically generate electrical energy from streams of hydrogen containing gas. They are scalable and suitable for a wide variety of applications having a wide range of power requirements. By way of example, fuel cells can be used to power portable devices requiring a few watts as well as backup and peaking power applications requiring several megawatts. Fuel cells are also versatile insofar as they are configurable for portable, stationary and/or transportable power supply requirements.

High-temperature fuel cells are generally favored in stationary applications such as power generation, grid backup and combined heat and power systems. Although they offer the advantages of high efficiency and fuel flexibility, high temperature fuel cell systems are typically complex, large and heavy. They can have relatively slow start-up times.

A particularly useful high temperature fuel cell design is a Solid Oxide Fuel Cell (SOFC). SOFCs commonly operate at temperatures between about 650 and 850° C. and typically exhibit electrical efficiencies between 40 and 60%, which is high, relative to other common fuel cell designs. Another benefit of SOFCs is that they can be designed to have relatively rapid start-up times. They are amenable for use as portable and transportable power sources.

A tubular solid oxide fuel cell 10 is illustrated generally in FIG. 1. SOFC 10 comprises at least three layers: an outer cathode layer 16, an inner anode layer 18, and an electrolyte layer 17 therebetween. Electrolyte layer 17 may be a ceramic tube made of solid oxide electrolyte material. The solid oxide electrolyte material can be made of material such as yttria-stabilized zirconia (YSZ) or scandia-stabilized zirconia (ScSZ). Tubular electrolyte layer 17 separates tubular anode layer 18 and tubular cathode layer 16 and serves as a conduit for oxygen ions, which will combine with Hydrogen flowing within tubular anode 18 to form water and generate heat and electricity. Gadolinium-doped ceria (GDC) is a ceramic electrolyte commonly used in fuel cells. Anode layer 18 can be porous and can be e.g., a mixture of nickel and YSZ, nickel and ScSZ. Other oxygen ion conducting materials are also known in the art.

As a stream of hydrogen rich gaseous fuel, commonly a reformate mixture containing hydrogen, carbon monoxide, hydrocarbon-based gases and air, travels through an open bore 15 of SOFC tube 10, the hydrogen in the gas stream will oxidize at anode layer 18 with oxygen from e.g., air, supplied to cathode layer 16, and release electrons, e.g., H₂+O₂→H₂O plus electrons and heat. It is also possible to utilize the CO for the production of electricity in suitably designed fuel cells. CO can be oxidized at the anode with the generation of CO₂ and electrons by combining it with oxygen to form carbon dioxide.

Cathode layer 16 can be porous and can comprise a mixture of e.g., Yttria-stabilized zirconia (YSZ) or Scandia-stabilized zirconia (ScSZ) and a perovskite-based material such as lanthanum strontium manganite (LSM) or lanthanum strontium cobalt (LSC). GDC is also a suitable material. Cathode layer 16 facilitates the electrochemical reaction of oxygen reduction by accepting the electrons. These electrons can be collected with known current collectors (not shown) to supply the current produced by the oxidation of hydrogen.

The hydrogen rich fuel for a fuel cell can be produced by a fuel reforming reactor that converts reformable hydrocarbon-based fuel into a hydrogen rich gaseous reformate mixture that is well suited for use with a fuel cell. The conversion of a gaseous or vaporized liquid reformable hydrocarbon fuel into a hydrogen-rich reformate can be carried out in accordance with known fuel reforming operations such as dry reforming, autothermal reforming, steam reforming, and catalytic partial oxidation (CPOX) reforming. The reformate gas typically contains hydrogen and carbon monoxide, a product commonly referred to as “synthesis gas” or “syngas,”

CPOX reforming, or simply CPOX, is an efficient way of converting readily available reformable fuels, such as methane, ethane, propane, and vaporized kerosene, into hydrogen-rich reformate. The reformates can be supplied to fuel cell stacks, for example, those having nominal power ratings of anywhere from 100 watts to 100 kilowatts, and all power ratings in between and beyond. Among the advantages of CPOX reforming, is that the reaction is exothermic, in contrast to steam reforming and dry reforming, which are endothermic reactions that require an external source of heat.

A conventional CPOX reforming reactor column 20 is shown generally in FIG. 2. CPOX reformer 20 comprises a tubular wall 21 and a bed of CPOX catalyst 22 filling the inner bore of tubular wall 21. In operation, a fuel stream 23 of a gaseous or vaporized liquid reformable fuel flows through CPOX catalyst bed 22. CPOX catalyst 22 reforms fuel 23 into a reaction product syngas stream 24, which comprises a gaseous mixture of hydrogen, water vapor, carbon monoxide and carbon dioxide. Hydrogen rich syngas reaction product mixture 24 can then be fed to the inlet of a fuel cell, such as SOFC 10 to complete the generation of electricity from hydrocarbon fuel.

SOFC technology, however, is not without its challenges. The high operating temperature of SOFCs can degrade, corrode and/or deform many materials including metals. Issues with thermal expansion coefficient differentials can destabilize various structures including current collector connections. Thus, the lifetime of fuel cells can be shorter than other devices in a power generation system. U.S. Pat. No. 9,774,055, for example, discloses ways to address thermal expansion of SOFC components. The entire contents of this patent are incorporated herein by reference.

Fuel cell interconnection systems, which connect and transfer electrical power between cells and from fuel cell arrays are also susceptible to high-temperature material incompatibilities. Degradation, corrosion, deformation and/or destabilization is unacceptable, as it can lead to unstable performance and premature fuel cell failure. These issues are further exacerbated by physical impacts and vibrations incurred during portable applications due to the brittle nature of many SOFC designs.

Ceramic based interconnectors can satisfy some of the material incompatibility issues. However, they have proven to be brittle, costly, and problematic to manufacture, shape and integrate with other cell components. Metallic interconnects tend to be less brittle, potentially less expensive, more malleable, and they lend themselves to being joined to electrodes, other current collectors and stack components using standard welding or brazing techniques. However, as previously noted, metals can be problematic in high-temperature fuel cell environments.

As can be seen, there is a need for improved fuel reformers and fuel cell power generation systems and components to collect the electric current generated thereby. It is desirable that these systems combine the efficiencies and other benefits of high-temperature operation, with the stability, durability and convenience of lower temperature operation. It is also desirable to combat the high costs associated with system failures noted above, as well as other drawbacks and shortcomings of the prior art.

Other advantages will be apparent from the following descriptions and the accompanying drawings.

### SUMMARY OF THE INVENTION

Generally speaking, in accordance with the invention, an improved fuel reforming and fuel cell electricity generating system is provided, which efficiently converts gaseous or vaporized liquid fuel into electricity. Systems and devices in accordance with the invention address problems associated with high temperature fuel cell operation, provide an improved fuel cell electrical interconnect system, and can provide a modular plug-together cartridge design to reduce replacement costs when only certain components need to be replaced. They can also provide a high ratio of current production to overall volume and fuel input.

The conversion of a gaseous or vaporized liquid reformable fuel to a hydrogen-rich gas mixture is a reaction product commonly referred to as “synthesis gas” or “syngas.” This conversion can be carried out in accordance with known fuel reforming operations such as steam reforming, dry reforming, autothermal reforming, and catalytic partial oxidation (CPOX) reforming. Systems in accordance with the invention can combine multiple operations, such as by using the heat and steam from one process to perform a second process. For example, the heat and steam from the fuel cell operation on the hydrogen produced from a primary fuel stream can be used to steam reform additional fuel from a secondary fuel stream and produce additional hydrogen. This additional hydrogen can be used to produce additional electricity without significantly increasing the size of the device. Thus, electricity generator systems in accordance with the invention can have a compact, low volume size and efficiently produce a surprisingly high amount of electricity for their size.

Efficiencies can be enhanced by balancing the conversion of the primary and secondary fuels into hydrogen and using that hydrogen to produce electricity. For example only 50-80% of the primary hydrocarbon fuel might be reformed to hydrogen in the first stage. This product them reacts electrochemically to produce heat and steam to then drive the secondary reaction, wherein the unconverted fuel from the first stage plus additional unreformed secondary fuel from the second stage can then be converted within the electrochemical device more efficiently, due to the hydrogen being recovered during the secondary steam reforming and the deceased nitrogen dilution associated with the system now operating in a sub-stoichiometric condition when calculated total fuel in is compared to POX air added.

In one embodiment of the invention, a proximal first end of an electricity generator includes air blowers and fuel inlets to receive and mix the reformable fuel and oxygen supply, e.g., air. This reformable fuel mixture is fed into the inlets of one or an array of fuel reforming CPOX reactor tubes. These CPOX tubes are preferably in the form of open bore tubes with gas permeable CPOX catalyst within or forming the walls of the tubes. As the reformable air/fuel mixture travels to the downstream end of the CPOX reactor tubes towards the distal end of the generator, it diffuses into the catalyst containing walls and is reformed to a hydrogen rich gaseous reaction product.

In one embodiment of the invention, when the reformed gaseous mixture exits the downstream end of the CPOX reactor tubes in the distal direction, it enters an upstream electrochemically active region of a fuel cell. The fuel cells can extend in the proximal direction over the outside of the CPOX reactor tubes, with each fuel cell surrounding a respective CPOX reactor tube. A distal end of the fuel cells can be plugged, to prevent entry of the reformate. This electrochemically inactive plugged, capped or otherwise obstructed end helps redirect the reformate in the proximal direction towards the downstream end of the fuel cells. As the reformate travels through the electrochemically active portion of the fuel cell, electricity, heat and steam are produced. The partially converted fuel from the CPOX reactor tubes thereby mixes with the heat and steam produced at the electrochemically active upstream end of the fuel cells, proximally from the inactive plugged distal end of the fuel cells, and then flows downstream in the proximal direction. Steam reforming can be initiated with this heat and steam on the unconverted fuel exiting the CPOX reactor tube and secondary fuel added to the fuel cell tube in the electrochemically active region.

Respective fuel cell tubes surround the CPOX reactor tubes and extend in the proximal direction from the inactive distal end, back towards the proximal end of the generator, around the outside of the CPOX reactor tubes. Thus, the gas exiting the downstream end of the CPOX reactor tubes is directed by the endcap or plug at the distal end of the fuel cell, back to the proximal end of the generator, outside the CPOX reactor tubes, and inside the fuel cell tubes. Likewise, hydrogen exiting through the walls of the CPOX reactor tubes will flow through the fuel cell tube. Thus, electricity (and heat and steam) is produced as the hydrogen rich gaseous reformate mixture from the CPOX reactor tubes flows downstream in the proximal direction to the outlets of the fuel cells at the proximal end of the generator. Electricity collecting structures at the distal ends of the fuel cells can be in contact with the inner anode layer and outer cathode layer of the fuel cells and can serve as current collectors and to electrically interconnect the fuel cell tubes. By making these connections at the inactive distal end, the electricity collectors can be thermally isolated from the heat generated by the fuel cells (and CPOX reactor tubes).

By plugging the extreme distal ends of the fuel cell tubes, and preventing the flow of the hydrogen rich gas therein, no electricity and heat will be produced at this inactive plugged end. The majority of the fuel cells can be located within an enclosure, with the inactive distal ends, including the cathode and anode layers thereof, extending therethrough. Therefore, these inactive ends will be relatively cool, compared to the active portion of the fuel cell tubes within the enclosure. Those inactive ends can be packed with insulating material, and is preferably doped with copper to help prevent carbon deposition. A layer of insulation can be used to further insulate the inactive ends from the active portion within the enclosure. The current collection system can be electrically connected to these inactive ends, outside the enclosure, which can be maintained at or near room temperature.

In one embodiment of the invention, a secondary fuel line supplying a secondary stream of gaseous or vaporized liquid fuel extends through or preferably around respective CPOX reaction tubes. This secondary gas stream is heated as the CPOX reaction tube reforms the primary fuel into the syngas. As discussed above, the syngas exiting the CPOX reactor tubes is fed to the active upstream end of the fuel cells, where it encounters the unobstructed inactive distal end of the respective fuel cell. As the syngas encounters the upstream active end of the fuel cell, it generates electricity, heat and steam. The pre-heated secondary fuel is then combined with the heat and steam and partially reformed fuel and syngas mixture to steam reform the unreformed primary fuel and the secondary fuel into additional hydrogen. This additional hydrogen is then used by the fuel cell to produce additional electricity as it proceeds downstream in the fuel cell towards the proximal end of the generator. Thus, electrical output can be increased without significantly increasing the overall dimensions of the device, and efficiencies can be increased. The depleted gas exiting the fuel cell can be passed through an afterburner, and the only emissions can be carbon dioxide and water vapor.

Current collector systems in accordance with the invention can connect a series of fuel cells or nested fuel cell/CPOX reactor tube pairs that combine a solid oxide fuel cell with a catalytic partial oxidation (“CPOX”) reformer tube. Interconnectors in accordance with the invention include an end cap, ring or other electricity connector electrically coupled to the inner anode of the fuel cell. A ring or other electricity connector can be electrically coupled to the outer cathode of a nearby reactor unit, and a busbar can electrically couple the electrical contacts at the anodes and cathodes. The interconnector can be constructed of materials able to withstand the rigors of the chemical and thermal reactions taking place in the reactor units. Preferably, the interconnector structures are strategically positioned to increase efficiency yet maintain structural stability of the overall system.

By thermally isolating the current collection interconnectors from the hottest parts of the fuel reformer/fuel cell reaction, many of the problems caused by high temperature operation and temperature fluctuation can be vastly reduced. Therefore, in one embodiment of the invention, the generator is thermally separated into a hot zone and a cool zone with thermal insulation. Alternatively or additionally, cooling ambient air can be used to keep the current collection system relatively cool. The CPOX reactor tubes and the active downstream portion of the fuel cells are advantageously thermally isolated in the hot zone, such as with an enclosure. A short inactive portion of the upstream-most ends of the fuel cells can extend through the thermal divider of the enclosure into the cool zone, which contains the electrical interconnects. A stream of cooling air can also be used to keep temperatures in the cool zone at relatively moderate levels. This cooling air stream can be provided by flowing the incoming air required by the fuel cell through the cool zone before sending it to the fuel cell.

In another embodiment of the invention, the stack of fuel cells and interconnects and related circuitry can be formed as an easy to remove, slide-in/plug-together module. For example, the individual fuel cells of a fuel cell unit can be slid over the respective CPOX reactor tubes of a base unit and the joined modules can be secured in place within a releasable enclosure. By forming an interconnected stack of fuel cell tubes as a plug-together cartridge module, the costs associated with fuel cell and interconnect component replacement or periodic maintenance can be greatly reduced, as only the less durable fuel cells and related components can be unplugged and replaced.

Accordingly, it is an object of the invention to overcome drawbacks of existing electricity generators and methods. Still other objects of the invention will be apparent from the specification and drawings. The scope of the invention will be indicated in the claims.

### BRIEF DESCRIPTION OF THE DRAWINGS

FIGS. 1A and 1B are schematic perspective and end views of a conventional solid oxide tubular fuel cell with at least three layers;

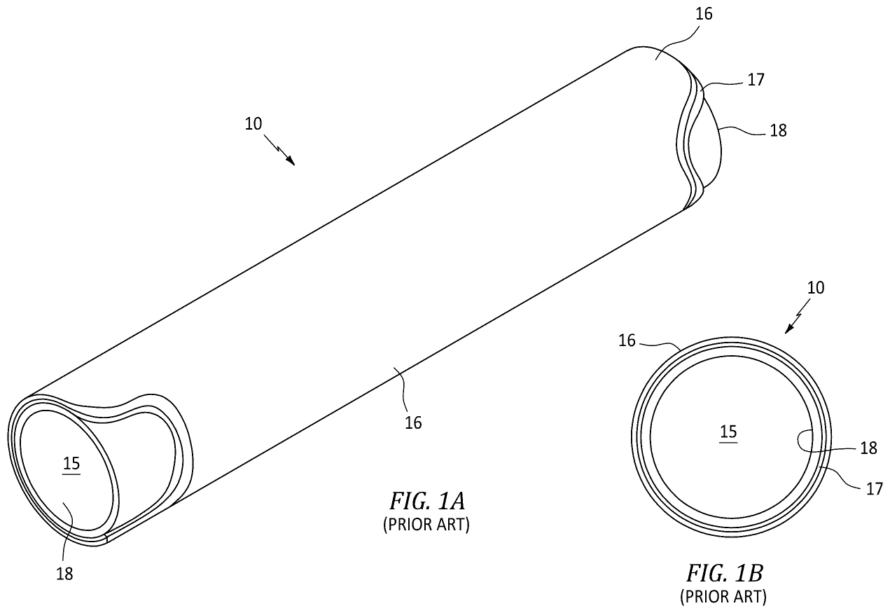

FIG. 2 is a cross sectional view of a conventional CPOX reactor column;

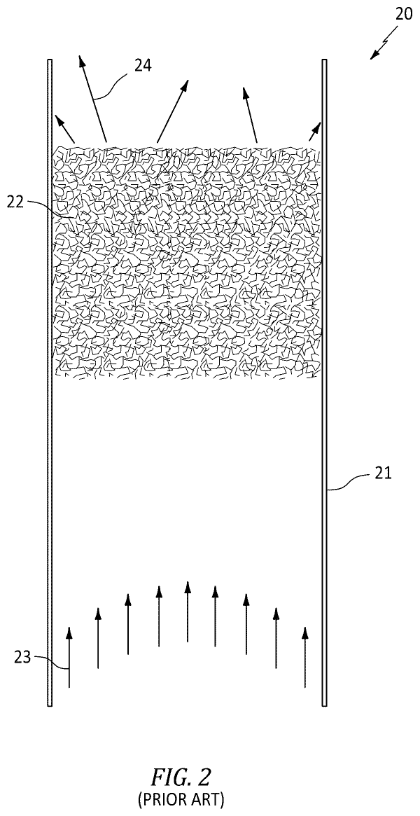

FIG. 3 is a schematic view of an electricity generator in accordance with an embodiment of the invention, including an array of CPOX reforming reactor tubes nested in a corresponding array of fuel cell tubes;

FIG. 4 is a side partial cross-sectional view of a portion of a current collector interconnect system in accordance with an embodiment of the invention;

FIG. 5 is a perspective view of an endcap and ring of the current collector system of FIG. 4;

FIG. 6 is a perspective view of an electricity generator in accordance with an embodiment of the invention;

FIG. 7 is an exploded view of the electricity generator of FIG. 6, with a side panel of a housing removed;

FIG. 8 is an enlarged partial view of the electricity generator of FIG. 7;

FIG. 9 is an exploded view of the electricity generator of FIG. 6; and

FIG. 10 is a side cross sectional view of the electricity generator of FIG. 6 in a disconnected condition.

### DETAILED DESCRIPTION OF THE PREFERRED EMBODIMENTS

Throughout the application, where compositions or components are described as having, including or comprising specific components, or where methods are described as having, including, or comprising specific method steps, it is contemplated that such compositions also consist essentially of, or consist of, the recited components and that such methods also consist essentially of, or consist of, the recited method steps.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition, an apparatus, or a method described herein can be combined in a variety of ways without departing from the focus and scope of the present teachings whether explicit or implicit therein. For example, where reference is made to a particular structure, that structure can be used in various embodiments of the apparatus and/or method of the present teachings.

The use of the terms “include,” “includes,” “including,” “have,” “has,” “having,” “contain,” “contains,” or “containing,” including grammatical equivalents thereof, should be generally understood as open-ended and non-limiting, for example, not excluding additional unrecited elements or steps, unless otherwise specifically stated or understood from the context.

The use of the singular herein, for example, “a,” “an,” and “the,” includes the plural (and vice versa) unless specifically stated otherwise.

Where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. For example, the methods described herein can be performed in any suitable order unless otherwise indicated herein or otherwise clearly contradicted by context. Moreover, two or more steps or actions can be conducted simultaneously.

At various places in the present specification, values are disclosed in groups or in ranges. It is specifically intended that a range of numerical values disclosed herein include each and every value within the range and any subrange thereof. For example, a numerical value within the range of 0 to 20 is specifically intended to individually disclose 0, 1, 2, 3, 4, 5, 6, 7, 8, 9, 10, 11, 12, 13, 14, 15, 16, 17, 18, 19 and 20, and any subrange thereof, for example, from 0 to 10, from 8 to 16, from 16 to 20, etc.

The use of any and all examples, or exemplary language provided herein, for example, “such as,” is intended merely to better illuminate the present teachings and does not pose a limitation on the scope of the invention unless claimed. No language in the specification should be construed as indicating any non-claimed element as essential to the practice of the present teachings.

Terms and expressions indicating spatial orientation or attitude such as “upper,” “lower,” “top,” “bottom,” “horizontal,” “vertical,” and the like, unless their contextual usage indicates otherwise, are to be understood herein as having no structural, functional or operational significance and as merely reflecting the arbitrarily chosen orientation of the various views of liquid fuel CPOX reformers of the present teachings illustrated in certain of the accompanying figures.

The term “ceramic,” in addition to its art-recognized meaning, shall be understood herein to include glasses, glass-ceramics, refractories and cements (i.e., ceramic-metal composites).

The expression “gas permeable” as it applies to a wall of a CPOX reactor unit or CPOX catalyst covered surface herein shall be understood to mean a wall or coating structure that is permeable to gaseous CPOX reaction mixtures and gaseous product reformate including, without limitation, the vaporized liquid or gaseous reformable fuel component of the gaseous CPOX reaction mixture and the hydrogen component of the reformate product.

The expression “liquid reformable fuel” shall be understood to include reformable carbon-and hydrogen-containing fuels that are a liquid at standard temperature and pressure (STP) conditions, for example, methanol, ethanol, naphtha, distillate, gasoline, kerosene, jet fuel, diesel, biodiesel, and the like, that when subjected to reforming, undergo conversion to hydrogen-rich reformates. The expression “liquid reformable fuel” shall be further understood to include such fuels whether they are in the liquid state or in the vaporized gaseous state, i.e., a vapor.

The expression “gaseous reformable fuel” shall be understood to include reformable carbon-and hydrogen-containing fuels that are a gas at STP conditions, for example, methane, ethane, propane, butane, isobutane, ethylene, propylene, butylene, isobutylene, dimethyl ether, their mixtures, such as natural gas and liquefied natural gas (LNG), which are mainly methane, and petroleum gas and liquefied petroleum gas (LPG), which are mainly propane or butane but include all mixtures made up primarily of propane and butane, and the like, that when subjected to reforming undergo conversion to hydrogen-rich reformates.

The term “reformer” shall be understood to include any device or apparatus in which one or more reforming reactions resulting in the conversion of reformable fuel to a hydrogen-rich reformate take place. The term “reformer” therefore applies to reactors in which such operations as steam reforming, dry reforming, autothermal reforming, catalytic partial oxidation (CPOX) reforming or a combination of two or more such reforming operations takes place, and to fuel cells having internal reforming capability.

The expression “reforming reaction” shall be understood to include the reaction(s) that occur during reforming or conversion of a reformable fuel to a hydrogen-rich reformate.

The expression “reforming reaction mixture” refers to a mixture including a vaporized liquid reformable fuel, a gaseous reformable fuel or combinations thereof, an oxidizer, for example, oxygen supplied as air, and in the case of steam or autothermal reforming, steam.

The expression “catalytic reforming” shall be understood to refer to any and all reforming reactions that are, or may be, carried out in the presence of a reforming catalyst and specifically include, without limitation, steam reforming autothermal reforming and catalytic partial oxidation (CPOX) reforming.

### CPOX Reforming

The CPOX reforming section of electricity generating systems in accordance with preferred embodiments of the invention can take several forms. In particular, the reformers can take the form of packed column reformers, wherein the CPOX catalyst fills or is formed across the interior of the column walls. More preferred are hollow open bore columns/tubes, where the walls of the reactor tube themselves comprise or contain gas permeable sections with the CPOX catalyst, and define an open gas flow passageway therethrough. In the hollow open bore reactor tube embodiment of the invention, the reaction mixture of reformable fuel and oxygen diffuses into the gas permeable catalyst containing wall (or wall portion or coating) as it travels from the upstream inlet end of the reforming reaction section to the downstream outlet of the reforming reaction section. Reformate and unused fuel and oxygen diffuse back to the open gas passageway and out the downstream outlet. CPOX Reformers are described, e.g., in U.S. Pat. Nos. 9,624,104, 9,627,699, 9,627,700, 9,627,701, and 9,878,908, the contents of which are incorporated herein by reference in their entirety.

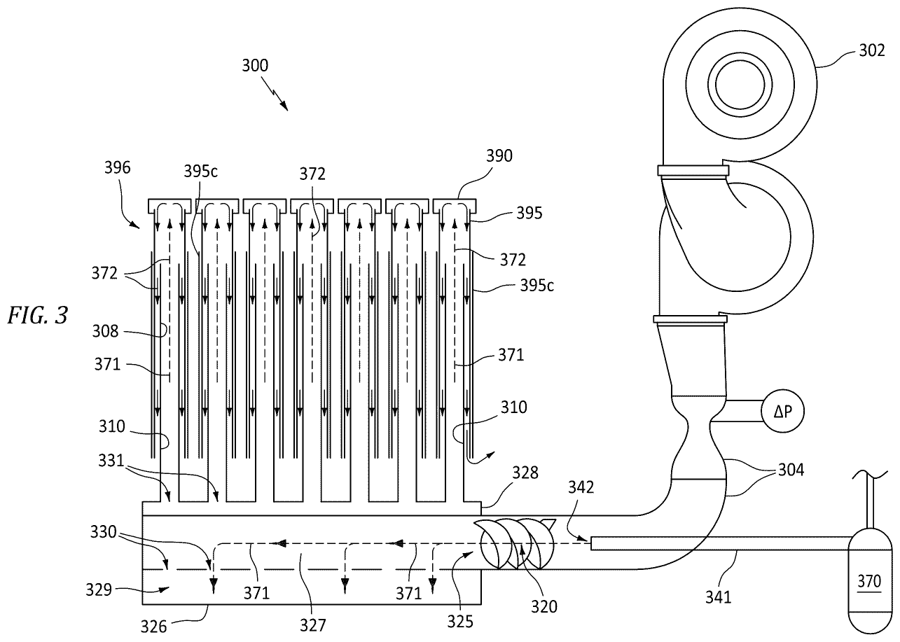

As indicated, electricity generation systems in accordance with the invention are preferably constructed as an assembly of fuel reforming reactor tubes integrated (nested) with an assembly of fuel cells, wherein each fuel cell is coupled with a respective fuel reforming reactor tube. An electricity generating system 300 in accordance with preferred embodiments of the invention is shown generally in FIG. 3, and will be discussed in greater detail below.

Electricity generator 300 includes an array of CPOX reforming reactor tubes 310. A preferred structure of the CPOX reforming reactor section of an integrated CPOX fuel reforming tube of the invention forms reactor tubes 310 as hollow, open bore tubes with CPOX catalyst forming all or part of the tube wall, or at least coated on the inside of the tube wall. This reduces back pressure and/or provides little or no opportunity or tendency for flashing or “run-away” thermal events. Better control of the temperature enables more integrated closer combinations of the CPOX reformer and fuel cell sections, which leads to a more compact and efficient electricity generating devices.

In one embodiment of the invention, the CPOX reactor tube nests within the fuel cell tube of a fuel reformer/fuel cell electricity generating combination in accordance with the invention. Reformable fuel and oxygen flow downstream from an inlet to an outlet of the CPOX reactor tube, and is partially or completely converted to a hydrogen rich reformate reaction product. Upon exiting the downstream CPOX reactor tube outlet, the hydrogen rich reformate reaction product gas mixture flows into the upstream end of the inner passageway of the fuel cell tube, with the anode layer defining the open bore of the tube. The upstream-most ends of the fuel cell tubes can be obstructed with plugs or caps to prevent electricity and heat from being generated at these ends, which can serve as relatively cool electricity connection sections. These caps/plugs redirect the hydrogen rich reformate to flow downstream through the fuel cell tubes, in a direction countercurrent to the flow within the CPOX reactor tubes, as it passes over the outside surface of the CPOX reactor tubes, and flows downstream to the fuel cell outlet, whereby it flows against the inner surface anode of the fuel cell tube and generates electricity.

The CPOX reforming reaction is highly exothermic. However, it does require a high temperature activation before it generates enough of its own heat to be self-sustaining. In one embodiment of the invention, the upstream proximal ends of the CPOX reformer tubes run through a catalytic oxidizer, which also functions as an afterburner for the exhaust from the fuel cells. To start the system, the cold fuel and air are ignited in the catalytic oxidizer, using a solid-state resistance-based ignitor. The after burner then activates and converts the fuel, which produces heat. That heat will transfer through the wall of the CPOX reformer tube, simultaneously pre heating the incoming reactants and the CPOX catalyst bed. It can also preheat the fuel cells. The CPOX reaction then starts once the activation temperate for the bed is reached (about 200-500° C.). This start-up procedure enables all of the CPOX reactors to light at approximately the same time, reducing overall start times and reducing thermal stress from uneven heating.

An especially preferred CPOX reactor design includes CPOX catalyst in or on the reactor walls only. The reactor walls surround a hollow, open bore gas flow passageway defined by the CPOX catalyst containing walls. The CPOX reactor unit can advantageously take the form of a CPOX catalyst-containing wall or coated/covered wall structure, surrounding a hollow, open bore. This hollow, open bore provides no obstruction, other than surface roughness, to impede the flow of the CPOX reaction mixture of reformable fuel and air and the outflow of reaction product. The inner surface of the wall is porous and gas permeable. The outer surface can be covered with a hydrogen barrier constructed to prevent or control the loss of hydrogen through the wall. The gaseous reformable reaction mixture of fuel and oxygen flowing through the hollow bore will diffuse into the catalytic wall, where the catalyzed partial oxidation into hydrogen and carbon monoxide will take place, and then back into the open bore. The hydrogen rich reformate reaction product will then flow from the outlet of the CPOX reaction section into the upstream end of the fuel cell.

### Hydrogen Barrier

To prevent or control the loss of hydrogen product through the gas-permeable wall, a hydrogen barrier should be disposed on or over the outer surface of the wall, or at least the outer surface of the wall corresponding to the reforming reaction zone portion of the wall. Materials capable of functioning as effective hydrogen barriers should be thermally stable at the temperatures typical of reforming reactions and should be sufficiently dense to prevent or deter permeation or diffusion of reformate gases, particularly hydrogen, therethrough.

A variety of ceramic materials (inclusive of glasses and glass-ceramics) and metals meeting these requirements are known and are suitable for providing the hydrogen barrier. Specific materials for the hydrogen barrier include, for example, aluminum, nickel, molybdenum, tin, chromium, alumina, recrystallized alumina, aluminides, alumino-silicates, titania, titanium carbide, titanium nitride, boron nitride, magnesium oxide, chromium oxide, zirconium phosphate, ceria, zirconia and doped zirconia oxides, mulite and the like, admixtures thereof and layered combinations thereof.

Where the nature of the material constituting the hydrogen barrier permits, the hydrogen barrier to be applied to at least that portion of an outer surface of a reactor unit wall corresponding to the reforming reaction zone as a pre-formed layer, foil, film or membrane. The hydrogen barrier can be bonded to the wall with a refractory adhesive. Alternatively, the hydrogen barrier can be formed on an outer surface by employing any suitable deposition method, for example, any of the conventional or otherwise known ceramic-coating and metal-coating techniques such as spray coating, powder coating, brush coating, dipping, casting, co-extrusion, metallizing, and the like, and any of their many variations. A suitable range of thickness for a hydrogen barrier will depend primarily on the hydrogen permeability characteristics of the selected barrier material and the gas permeability characteristics of the wall enclosing the reforming reaction zone. Such thickness should be readily determined by those skilled in the art employing known and conventional experimental techniques. For many barrier materials and perovskite-containing reactor wall structures, the thickness of the hydrogen barrier can vary from about 2 microns to about 15 microns, preferably between about 5 microns to 12 microns.

### Perovskite Wall Structure

The gas permeable CPOX catalyst-containing wall or covering section of a CPOX reactor unit can include a ceramic portion or can be entirely ceramic. The CPOX catalyst containing wall section can be a porous substrate, for example, a porous substrate including a ceramic or a porous ceramic. At least the section of the wall including the CPOX catalyst can be or can include a perovskite. For example, greater than about 20% or greater than about 50% by weight of such wall section can be a perovskite. The CPOX catalyst can be disposed within the wall and/or disposed on an internal surface of the wall, or used to form the wall. For example, a CPOX catalyst or CPOX catalyst system can be deposited on a wall and/or surface of the wall, such as the internal surface of the wall, for example, by impregnation, wash coating, or an equivalent procedure. The CPOX catalyst can also partially or completely form the structure of the wall, i.e., a wall entirely or partially formed of the CPOX catalyst material.

The hydrogen-producing capacity of the reformer is a function of several factors including the type, amount (loading and distribution of reforming catalyst, i.e., perovskite, and any other reforming catalyst(s) that may be present within the gas-permeable wall), the characteristics of the porous structure of the wall (characteristics influencing the gas-permeability of the walls and therefore affecting the reforming reaction) such as pore volume (a function of pore size), the principal type of pore (mostly open, i.e., reticulated, or mostly closed, i.e., non-reticulated), and pore shape (spherical or irregular), the volumetric flow rates of the reforming reaction mixture, reforming reaction temperature, back pressure, and the like.

Perovskites possess catalytic activity for reforming reactions such as steam reforming, autothermal reforming and CPOX reforming and are therefore useful not only for the fabrication of the wall structure of catalytic reformers corresponding to their reforming reaction zones, they can also supply part or even all of the reforming catalyst.

Any of the conventional and otherwise known perovskites can be utilized herein for the construction of the wall(s) and/or wall section(s) of reformers of all types, including those of the catalytic and non-catalytic variety. Suitable perovskites are described, for example in U.S. Pat. Nos. 4,321,250; 4,511,673; 5,149,516; 5,447,705, 5,714,091; 6,143,203; 6,379,586; 7,070752; 7,151,067; 7,410,717; 8,486,301, and 10,676,354. The entire contents of these patents is incorporated herein by reference.

Perovskite catalysts are a class of reforming catalysts, useful in embodiments of the invention as they are also suitable for the construction of the catalytically active wall structures of a catalytic reformer. Perovskite catalysts are characterized by the structure ABX₃ where “A” and “B” are cations of very different sizes and “X” is an anion, generally oxygen, that bonds to both cations. Examples of suitable perovskite CPOX catalysts include LaNiO₃, LaCoO₃, LaCrO₃, LaFeO₃ and LaMnO₃.

A slight modification of the perovskites generally affects their thermal stability while B-site modification generally affects their catalytic activity. Perovskites can be tailor-modified for particular catalytic reforming reaction conditions by doping at their A and/or B sites. Doping results in the atomic level dispersion of the active dopant within the perovskite lattice thereby inhibiting degradations in their catalytic performance. Perovskites can also exhibit excellent tolerance to sulfur at high temperatures characteristic of catalytic reforming.

Examples of doped perovskites useful as reforming catalysts include La₁₋ₓCeₓFeO₃, LaCr_{1-y}Ru_{y}O₃, La₁₋ₓSrₓAl_{1-y}Ru_{y}O₃ and La₁₋ₓSrₓFeO₃ wherein x and y are numbers ranging, for example, from 0.01 to 0.5, from 0.05 to 0.2, etc., depending on the solubility limit and cost of the dopants.

Some specific perovskites that can be utilized for the construction of the wall(s)/wall section(s) of the reformer herein are lanthanum strontium manganite (LSM), lanthanum strontium ferrite (LSF), lanthanum strontium cobalt ferrite (LSCF), lanthanum calcium manganite (LCM), lanthanum strontium chromite (LSC), lanthanum strontium gallate magnesite (LSGM), their mixtures with each other and with other perovskites.

The total amount of perovskite employed in the fabrication of the reformer wall(s)/wall section(s) can vary over fairly wide limits provided such amount contributes significantly to their mechanical strength. In general, the entire wall or the reforming section of the reformer, can contain at least 20 weight percent, preferably at least 50 weight percent, and in other embodiments, at least 80 weight percent and up to 100 weight percent, perovskite.

### Ceramic Wall Structure

Ceramics are an especially suitable class of materials for the construction of reformer wall structures, due to their relatively low cost compared to many of the refractory metals and metal alloys that are also useful for this purpose. The comparative ease with which such ceramics can be formed into tubular gas-permeable structures of fairly reproducible pore type employing known and conventional pore-forming procedures and the generally highly satisfactory structural/mechanical properties of ceramics (including coefficients of thermal expansion and thermal shock performance) and resistance to chemical degradation make them particularly advantageous materials.

Suitable ceramics include the entire wall structure of a CPOX reactor unit include, for example, spinels, magnesia, ceria, stabilized ceria, silica, titania, zirconia, stabilized zirconia such as alumina-stabilized zirconia, calcia-stabilized zirconia, ceria-stabilized zirconia, magnesia-stabilized zirconia, lanthana-stabilized zirconia and yttria-stabilized zirconia, zirconia stabilized alumina, pyrochlores, brownmillerites, zirconium phosphate, silicon carbide, yttrium aluminum garnet, alumina, alpha-alumina, gamma-alumina, beta-alumina, aluminum silicate, cordierite, magnesium aluminate, and the like, various ones of which are disclosed in U.S. Pat. Nos. 6,402,989 and 7,070,752, the entire contents of which is incorporated herein by reference; and, rare earth aluminates and rare earth gallates various ones of which are disclosed in U.S. U.S. Pat. Nos. 7,001,867 and 7,888,278, the entire contents of which are incorporated by reference herein.

Refractory binders that can be useful for the fabrication of the wall(s)/wall section(s) of a reformer include conventional and otherwise known materials as calcium aluminate, silica and alumina admixed with one or more metal oxides such as calcium oxide, strontium oxide and sodium oxide.

In certain embodiments of the invention, the amount of CPOX catalyst within the catalyst-containing wall section of a CPOX reactor unit can increase along the length of the wall section. For example, the amount of catalyst can increase or decrease in the direction from the inlet end to the outlet end of the CPOX reactor unit, and/or can decrease from the central inner surface to the outer external surface of the wall. Such gradients of CPOX catalysts can be present in the CPOX reaction zone of a CPOX reactor unit. This can help control the temperature at the ends of the CPOX reaction section. Preferred CPOX catalysts to be incorporated into the ceramic wall structure are well known in the art. These include the precious metal catalysts, such as platinum, palladium, nickel, rhodium, and the like, as well as iron containing catalysts, and combinations and alloys thereof.

### Reactor Unit Assemblies

Each CPOX reactor unit will typically take the form of an elongated tube having a wall with an internal surface and an external surface. Preferably, the wall of the CPOX reactor unit encloses a hollow, open gas flow passageway and defines an inlet at the upstream end for receiving fluid flow of a gaseous CPOX reaction mixture and an outlet at the opposite downstream end for discharging the products of the reformation reaction. In certain preferred embodiments of the invention, each CPOX reactor unit can be in thermal communication with at least one adjacent CPOX reactor unit of the array. However, where the fuel cell tube extends over the CPOX reactor tube, the fuel cell tube body could interfere with heat transfer and the reactor tubes will not be in direct thermal communication. Therefore, passing an upstream end of the CPOX tubes through the after burner and using the after burner to provide start-up heat can be effective, because the after burner can be in direct heat transfer fluid communication with the CPOX reactor tube body structure. The CPOX reactor units can have at least a section of its wall, including the internal surface defining the hollow gas passageway, include the CPOX catalyst. The CPOX catalyst-containing wall section should be gas-permeable to allow the gaseous CPOX reaction mixture to diffuse therein and to allow the hydrogen-rich reaction product reformate to diffuse back into the central gas flow passageway. The CPOX catalyst-containing wall section must remain structurally stable under CPOX reaction conditions.

The CPOX reaction and operation of the fuel cell are exothermic. With respect to the array of spaced-apart CPOX reactor/fuel cell combined units and their thermal communication, the combined units should be spaced apart at a maximum distance that is close enough for the heat of exotherm given off from the combined unit to provide enough activation heat energy to maintain a CPOX and fuel cell reaction in one or more adjacent combined units. On the other hand, the combined units should be spaced at a distance far enough apart to permit control of the temperature of the combined units. That is, the combined units should be spaced far enough apart, so that heat loss can occur from a combined unit to prevent heat induced. Those of ordinary skill in the art will understand how to size and space specific combined units. With such positioning, an array of spaced-apart combined units can provide an appropriate thermal balance among the array and can facilitate thermal uniformity throughout or across the array.

For example, the maximum distance between adjacent first and second CPOX reactor and fuel cell combined units can be that distance beyond which the heat of exotherm produced from a first combined unit is insufficient to maintain operation in the second combined unit. Thus, the maximum distance can be that distance beyond which, during a steady-state mode of operation, the temperature of an array of combined units falls below a predetermined minimum array temperature, for example, below about 550° C. or about 650° C. Those of ordinary skill in the art will understand how to space the units to achieve this condition, based on the dimensions, reaction conditions, fuel, etc.

The minimum distance between adjacent combined units should be the distance beyond which so much heat is transferred among the combined units that damage occurs. That is, the combined units should be spaced at least far enough apart to prevent the heat from one combined unit to damage an adjacent combined unit. The predetermined maximum temperature can be a temperature that is tolerable by an inlet of a fuel cell in thermal and fluid communication with an outlet of a CPOX reactor, for example, about 850° C. or 900° C. Those of ordinary skill in the art will understand how to size and space the combined units to achieve this condition, based on the dimensions, reaction conditions, fuel, etc.

It should be noted that in certain preferred embodiments of the invention, the CPOX reactor tube is located inside the fuel cell, and under maximum efficiency operation, the combined CPOX reactor tube/fuel cell unit can be essentially autothermal. In fact, it could be operating endothermically, depending on the amount of steam reforming that is occurring.

### Manifold Gas Distribution

Another feature of the invention is a manifold for distributing gaseous CPOX reaction mixture to the inlets of the array of CPOX reactor units. For example, the manifold (or the manifold chamber) can be in fluid communication with the inlets of the CPOX reactor units. The manifold can be formed with a manifold housing, wherein the manifold housing defines a manifold chamber. The manifold can include a gaseous CPOX reaction mixture distributor disposed within, and extending for at least a majority of the length of, the manifold chamber. The gaseous CPOX reaction mixture distributor can be in fluid communication with a conduit that outputs a gaseous CPOX reaction mixture.

The gaseous CPOX reaction mixture distributor can include one or more outlets located at the respective inlets of the CPOX reactor units. In certain embodiments of the invention, the manifold can optionally include a heater and/or passive heating elements in thermal communication with the manifold chamber. The manifold can include a cavity, where the manifold housing defines the cavity. A heat resistant seal can be disposed within or adjacent to the cavity. The manifold housing typically includes a plurality of cavities, wherein the number and arrangement of the cavities coincide with the number and arrangement of the inlets of the CPOX reactor units. The seal can engage the inlet of the CPOX reactor unit thereby providing a gas-tight seal between the manifold housing and the inlet.

### Integrated System

A schematic view of electricity generator 300 incorporating the reformers and fuel cells disclosed herein is shown generally in FIG. 3. A gaseous or vaporized liquid fuel 370 from a tank or gas line is introduced into a conduit 304 via a fuel line 341 and a fuel inlet 342. Fuel 370 and oxygen containing gas such as air from a blower 302 (or oxygen tank) combine in a mixing zone 320 of conduit 304 to provide a gaseous CPOX reaction mixture 371. A mixer of any suitable kind, for example, a static mixer disposed within mixing zone 320 and/or a helically-grooved internal wall surface of conduit 304, can be included to provide gaseous CPOX reaction mixture 371 of greater compositional uniformity than otherwise would form in mixing zone 320.

Following its passage through the optional static mixer and/or contact with helical grooves disposed within mixing zone 320, gaseous CPOX reaction mixture 371 exits conduit 304 through an outlet 325 and enters a gas distributor 327 of a manifold 326, which is configured to provide a more uniform distribution of reaction mixture 371 to, and within, tubular CPOX reactor tubes 310. Thus, CPOX reactors 310 can comprise any of the reactor types discussed above. A preferred type is the hollow bore tube with walls comprising or including CPOX catalyst. Such an arrangement or other arrangement within the present teachings can provide a distribution of gaseous CPOX reaction mixture where the difference in flow rate of the gaseous CPOX reaction mixture within any two CPOX reactor units 310 is not greater than about 20 percent, for example, not greater than about 10 percent, or most preferably not greater than about 5 percent.

Returning to FIG. 3, manifold 326 includes a manifold housing, or enclosure, 328 defining a manifold chamber 329 within which gaseous CPOX reaction mixture (gas) distributor 327 is coupled to outlet 325 of conduit 304. Gaseous CPOX reaction mixture 371 exiting conduit 304 through outlet 325 enters gas distributor 327, thereafter passing outwardly through an arrangement of apertures (e.g., holes or slots) 330 located at the bottom or lower part of gas distributor 327, facing away from CPOX reaction units 310. Gas distribution can be in a line, or two-dimensional arrangement of multiple rows of outlets 325, corresponding to respective columns and rows of CPOX reactor units 310. CPOX reaction mixture 371 flows towards the respective inlets of units 310. The CPOX reaction gas mixture 371 flows to an arrangement of inlets 331 of tubular CPOX reactor units 310. Reaction mix 371 flows through CPOX reactor tubes 310 and is converted to a hydrogen rich reformate reaction product gas stream 372.

After exiting the respective outlets of CPOX reactor unit tubes 310, reformate 372 enters an upstream electrochemically active upstream end of a respective fuel cell 395 corresponding to the reactor tube it just exited. An end cap 390 at a position distal from the chemically active portion of fuel cell 395 opposes a downstream outlet 308 of reactor tubes 310. The inactive distal end of fuel cell 395 is coupled to an inner surface of end cap 390. Fuel cell 395 extends downstream in the proximal direction from endcap 390, countercurrent to the flow direction of reaction mixture 371 within reactor tube 310. Reformate 372 flows downstream in the proximal direction within fuel cell 395, around the outside of reactor tube 310 in a direction from the inner surface of end cap 390 towards the upstream end of reactor tube 310. An inner anode layer of fuel cell 395 opposes the outside surface of reactor tube 310 and forms a downstream conduit for reformate 372 between the inner surface of fuel cell 395 and the outer surface of CPOX reactor tube 310.

After undergoing the CPOX reaction in reactor tubes 310, reaction mixture 371 will have been transformed into hydrogen rich reformate reaction product gas stream 372. Reformate 372 comprises hydrogen, carbon monoxide, carbon dioxide, unreacted fuel and air. In one embodiment of the invention, reaction product gas stream 372 will flow directly into an inlet of one of the fuel cells 395, positioned to extend in alignment with a downstream end of reactor tubes 310. In the embodiment of the invention depicted in FIG. 3, reaction product gas stream 372 exits tubes 310 into an active upstream end of fuel cells 395 and is directed back around the outside surface of reactor tube 310 in a direction opposite the downstream direction of reaction mixture 371 through reactor tube 310. This hydrogen rich reaction product 372 flows along the inner anode layer of fuel cell 395 and generates electricity, heat and steam. This electricity is collected by end cap 390, as discussed below. It should be noted that in preferred embodiments of the invention, the reformate exits CPOX reactor tube 310 within an electrochemically active region of fuel cell 395. As it travels downstream through fuel cell 395, reaction product 372 will include water electrochemically produced within in the active region of fuel cell 395 between the distal end of reactor tube 310 and end cap 390. It will then be directed back down fuel cell 395 by cap 390, the inner surface of fuel cell 395, and the outer surface of reactor tube 310. In preferred embodiments of the invention, the outlet of the CPOX reactor tube should be between about 10-40 mm before the end of the electrochemically active part of the fuel cell.

In another embodiment of the invention, a secondary fuel line extends through or preferably around each reactor tube 310. As discussed above, when reformate 372 exits reactor tube 310, it encounters an active region of fuel cell 395, and produces electricity, heat and steam. By flowing secondary fuel into this active region, the secondary fuel (and any unreformed primary fuel) will be subject to steam reforming, to produce additional hydrogen. A secondary manifold and optionally a secondary blower unit for the secondary fuel lines will help ensure even gas distribution. Preferred configurations for the use of a secondary fuel line are discussed below.

In another embodiment of the invention, generator 300 comprises an outer enclosure (not shown). A layer of thermal insulation (not shown) extends across, perpendicularly, to reactor unit tubes 310, wherein reactor tubes 310 extend through the insulation layer. The insulation layer separates the enclosure into a relatively cool zone and a relatively hot zone. The cool zone houses endcaps 390, as well as wiring and circuitry systems. The CPOX reaction portion of reactor tube 310 and the electrically active portion of fuel cell 395 are located in the hot zone. Cooling air can be blown through the cool zone to further moderate temperatures. This air can be directed to the fuel cells as an oxygen source. Maintaining the end caps and other circuitry in a cooler zone helps with their longevity, as they are not subjected to extreme temperatures for long periods of time. An afterburner can be used to finish combustion of unconverted reactants. It can also be used to combust the unconverted fuel flowing through the system prior to achieving start-up activation to increase the temperature until the CPOX reactor tubes and fuel cells become active and self-sustaining, as discussed above.

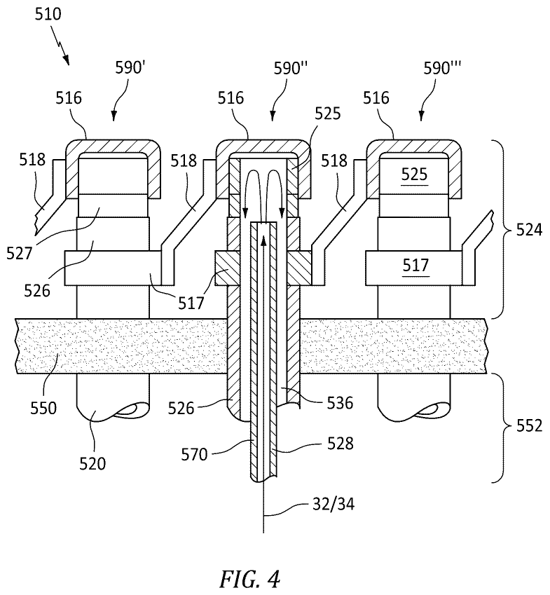

FIG. 4 depicts three combined fuel reformer/fuel cell reactor units 590′, 590″, and 590′″ connected one to the other by a set of three respective interconnect assemblies 515, of a current collector system 510, in accordance with a preferred embodiment of the invention. Solid oxide fuel cell 520 of unit 590′ has an outer cathode layer 526 and an inner anode layer 525. Anode layer 525 extends past the end of cathode layer 526, with its outer surface exposed. Thus, both anode 525 and cathode 526 are exposed for electrical connection. Each interconnect 515 includes an endcap 516, which is electrically coupled to exposed anode 525. Endcap 516 has a similar function and construction to end cap 390 of FIG. 3. An electrical connector conforming to the surface of cathode 526, such as a ring 517 is electrically coupled to the outside of cathode layer 526 of adjacent reactor unit 590″. A busbar 518 connects endcaps 516 and rings 517. In this manner a plurality of fuel reformer/fuel cell units 590 are electrically and physically interconnected in series. In an alternative embodiment of the invention, the reactor units can be interconnected in parallel.

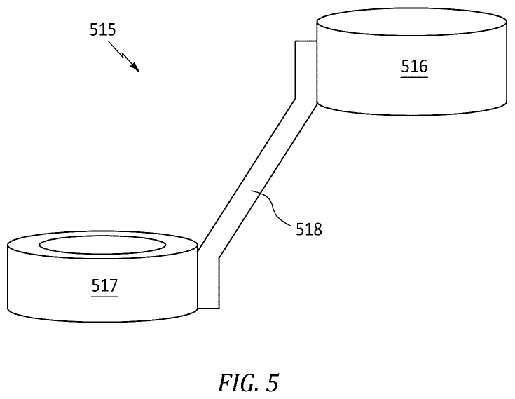

Referring to the embodiment of the interconnect shown in FIG. 4, FIG. 5 shows that interconnect 515 includes ring 517, having an open cylindrical geometry, connected to cap 516, having an open bottom cylindrical geometry, with ring 517 and cap 516 connected by busbar 518. Cylindrically shaped ring 517 and cap 516 follow the contours of the corresponding underlying structures, namely cathode 526 and anode 525, respectively, thereby providing high surface area contact and optimal electrical connectivity. Those of skill in the art will appreciate that other geometries and configurations can also provide high connectivity, such as bent, springy connections. The position of ring 517 relative to endcap 516 can be adjusted by changing the length and/or angle of connecting busbar 518. In preferred embodiments of the invention, interconnect 515 can be constructed of copper, silver, nickel, stainless steel or mixtures thereof, as well as solder as needed. It is preferred that ring 517, endcap 516 and busbar 518 are constructed of substantially identical materials, so the structure as a whole exhibits substantially similar properties, such as expansion coefficients, conductivity, and deterioration and corrosion profiles.

### Detachable Modular Plug-in Systems

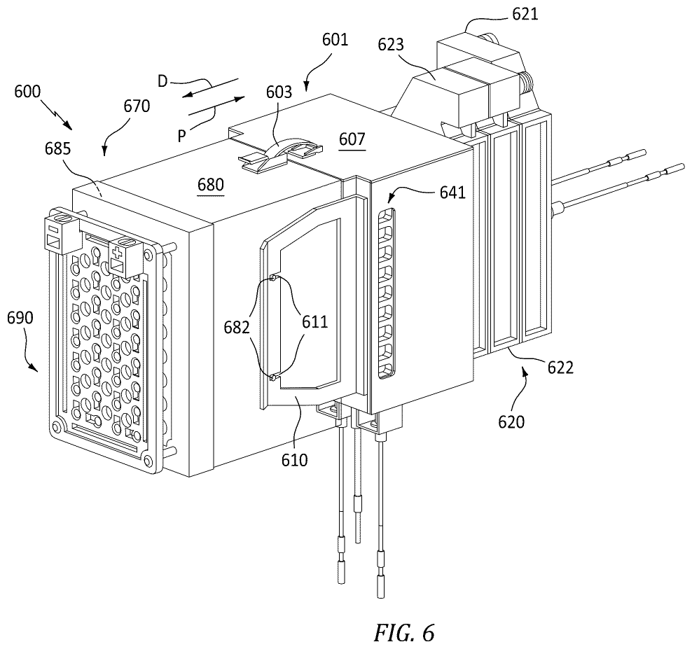

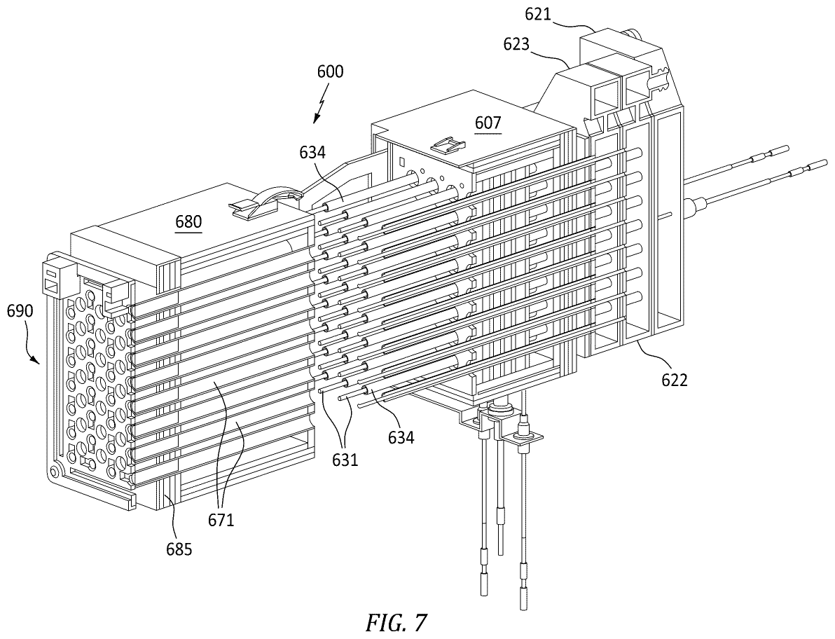

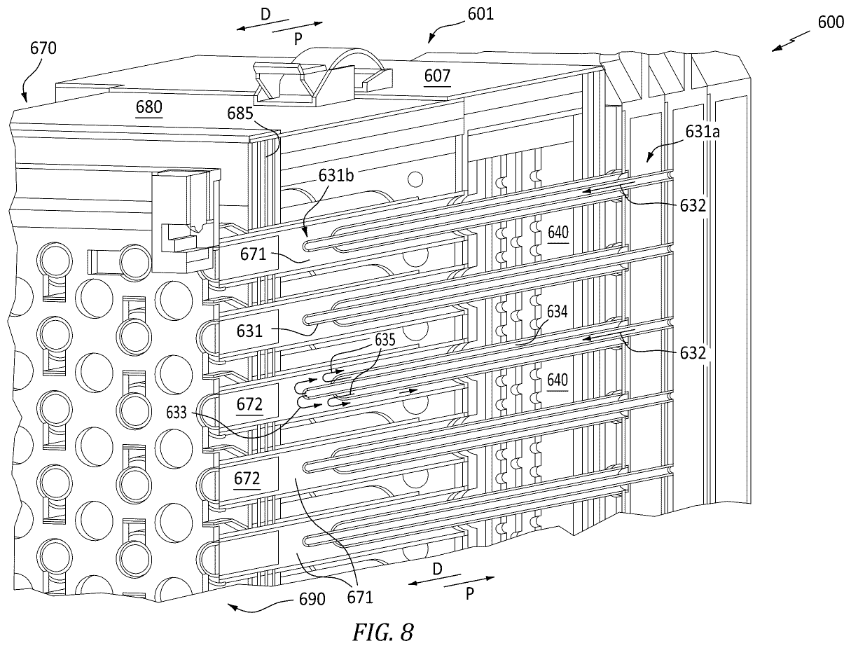

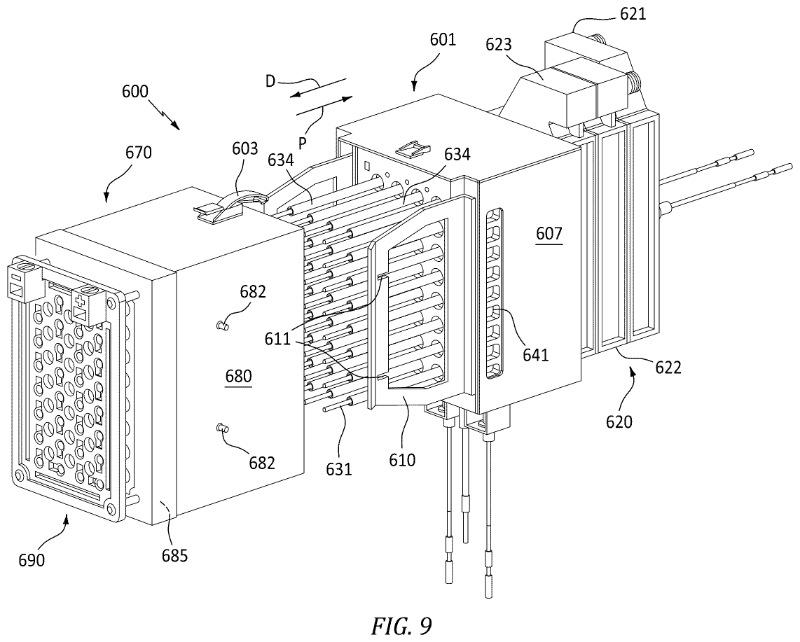

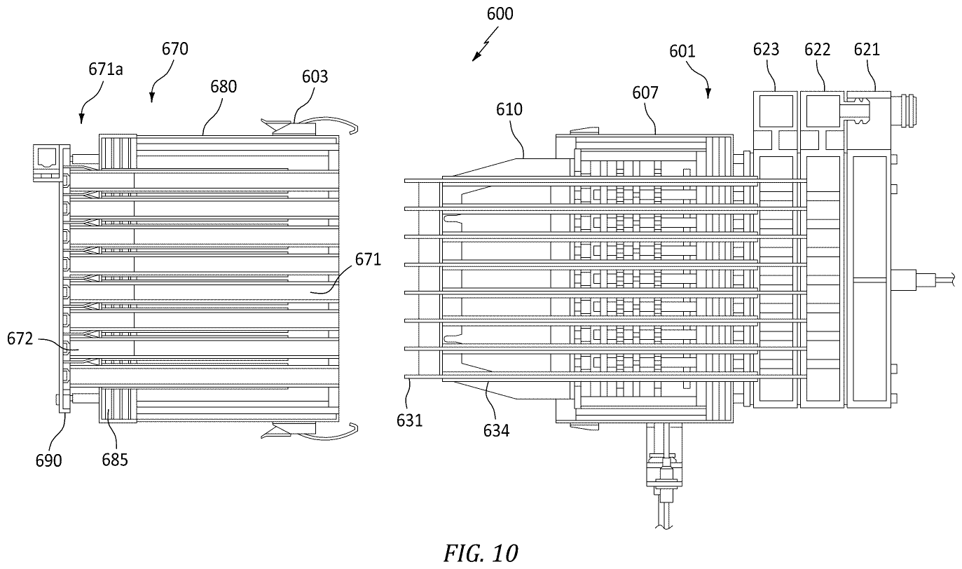

A plug together modular combined fuel reformer/fuel cell electricity generating device in accordance with a preferred embodiment of the invention is shown generally as a modular electricity generator 600 in FIGS. 6-10. Electricity generator 600 is formed with a proximal base unit 601 releasably coupled to a distal replaceable fuel cell stack unit 670. An overall distal direction D is defined from proximal base 601 towards distal fuel cell unit 670. A proximal direction P is defined from distal fuel cell unit 670 towards proximal base unit 601.

The replaceable cartridge concept disclosed herein will enable upgrades to slightly longer or wider fuel cells to be add in a new cartridge. This will offer the potential for power upgrades. Systems that require additional cycling stability could be fitted with a cell cartridge containing cells that optimized for cycling. Thus, the replaceable cartridge design enables the customer to upgrade their cell technology over time as desired.

Base 601 includes a base housing 607 and fuel cell unit 670 includes a fuel cell housing 680. Base housing 607 is secured to fuel cell housing 680 with a pair of flexible D-shaped latches 610, having a pair of notches 611 that interact with a pair of posts 682 on an outer surface of a housing 680 of fuel cell unit 670. Posts 682 have the same width from each other as notches 611. To secure base 601 to fuel cell unit 670, latches 610 are spread apart, fuel cell unit 670 is mated with base unit 601, and then latches 610 are released, with notches 611 secured around posts 682. A security hook 603 can provide additional security. Base housing 607 meets with fuel cell housing 670 to form an enclosure to isolate the heat generating reactive portions (CPOX reactor and fuel cell) of generator 600. Housing 607 also includes a catalytic oxidizer, which can function as an after burner, to provides the heat to raise the system temperature to start-up temperature, preheat the incoming reactants, both the fuel side and the cathode side, and complete combustion of the exhaust, as is discussed above.

A blower assembly 620 is mounted on the proximal end of base unit 601. An air blower 621 supplies ambient air as an oxygen containing gas to generator 600 for the outer cathode layer of the fuel cell array of generator 600, as discussed below. An air/fuel blower 622 is coupled to an air inlet and the outlet of a fuel line supplying gaseous fuel or vaporized liquid fuel and supplies a reformable air/fuel mixture to the CPOX reformer section of generator 600, as discussed below. The air: fuel ratio can be adjusted as needed. A combination blower 623 is also coupled to a fuel line. Blower 623 can selectively supply either a combustible air/fuel mixture to help during start-up, until generator 600 reaches steady-state operating temperatures. Once that temperature is reached, combination blower 623 can supply a stream of gaseous fuel only to a steam reforming section of generator 600, as discussed below. Each of blowers 621, 622 and 623 have an air and/or fuel intake and a distribution manifold to supply substantially even gas streams to the CPOX and fuel cell tubes. Blower systems are described, e.g., in U.S. Pat. No. 11,708,835, WO 2024/162969, and WO 2023/219664, the entire contents of which are incorporated herein by reference.

Base unit 601 includes housing 607, containing an assembly of hollow, open bore CPOX reaction tubes 631. CPOX reaction tubes 631 comprise a CPOX catalyst wall surrounded with an outer hydrogen barrier. The open bore of tubes 631 are in fluid communication with the manifold of air/fuel blower 622. An adjustable CPOX reaction mix of air and fuel 632 is blown into an upstream end 631a of CPOX reaction tubes 631. As CPOX reaction mixture 632 travels downstream in the direction of arrow D, it diffuses into the catalytic wall of reaction tubes 631 and is reformed into a hydrogen rich reformate 633, which exits a downstream end 631b of reaction tubes 631. Downstream end 631b should be positioned within the electrochemically active region of fuel cell 671 to produce steam to steam reform the secondary fuel feed and further steam reforming reaction, as is discussed below. Also produced are heat, H₂O, CO, and CO₂.

Base unit 601, with blowers 621, 622, and 623 coupled to CPOX reaction tubes are relatively durable, and can withstand relatively long periods of operation. Fuel cell unit 670 contains the fuel cells and current collection electronics. Fuel cell unit 670 is less durable and also less expensive to replace than base unit 601.

Fuel cell unit 670 includes an assembly of fuel cells 671 surrounded by fuel cell housing 680. Fuel cells 671 are preferably solid oxide fuel cells, and include an outer cathode layer, an inner anode layer, and an electrolyte layer therebetween. In preferred embodiments of the invention, each fuel cell 671 includes an end plug 672 which obstructs a distal end 671a of fuel cells 671. End plug 672, preferably of insulating material, prevents the hydrogen rich reformate from reaching the inner anode layer of fuel cell 671 at distal end 671a thereof. Therefore, inactive distal ends 671a of fuel cells 671 do not produce any electricity and heat. Inactive distal end 671a of fuel cells 671 can extend to the outside of fuel cell housing 680 and the enclosure formed with base housing 607. An insulation layer 685 is located at the inner surface of fuel cell housing 680. Distal ends 671a of fuel cells 671 extend through insulation layer 685 prior to exiting fuel cell housing 680. End plug 672 prevents any heat from being generated at the location where distal ends 671a of fuel cells 671 extend through insulation layer 685. With this construction, distal ends 671a and the electrical connections thereto are relatively cool, and can be maintained at approximately ambient temperature.

A current collection system 690, similar to system 510, is used to interconnect each of fuel cells 671 and collect the current produced therefrom. Distal ends 671a of fuel cells 671 are connected one to the other (anode to cathode) by the electrical interconnects described above, to form current collection system 690. Current collection system 690 is on the distal side of insulation layer 685 and outside housing 680. Thus, current collection system 690 is essentially at ambient room temperature. Electrical connectors similar to connectors 516 and 517 can be used to electrically couple each fuel cell 671 to each other and to current collector 690. In this manner the plurality of fuel cells 671 are electrically and physically interconnected and the wiring and circuitry are isolated from the high temperatures within the enclosure of housing 607 joined to housing 680.

As hydrogen rich reformate stream 633 exits CPOX reaction tube 631, it encounters end plug 672 and is then directed in the proximal direction of arrow P within fuel cell 671. As this hydrogen rich mixture encounters the inner surface anode of fuel cell 671 downstream and in the proximal direction from distal end 671a, it produces electricity, as well as heat and steam.

A plurality of secondary fuel lines 634 extend in the distal direction of arrow D over the outside surface of respective CPOX reaction tubes 631. After operating temperatures are reached, and fuel cells 671 are producing electricity and steam, blower 623 blows a secondary stream of reformable fuel 635 downstream through secondary fuel line 634, around the outside of CPOX reaction tube 631, in the distal direction of arrow D. Secondary fuel stream 635 exits secondary fuel line 634 and encounters the heat and steam produced in the upstream active end of fuel cell 671, in the proximal direction from inactive distal end 671a.

The heat and steam cause steam reforming of secondary fuel stream 635, an endothermic process. The ratio of the reactants fed to the secondary fuel feed can be varied, from 100% fuel to O/C ratios suitable for CPOX reactions. This can be important to achieve maximal efficiency. The secondary fuel feed is generally operated at 100% fuel with no air added. The fuel is reformed using the electrochemically produced steam. This steam reforming of secondary fuel stream 635 produces additional hydrogen, which flows downstream through fuel cells 671 in the proximal direction of arrow P and produces additional electricity. This additional electricity is produced without significantly increasing the size of generator 600. Also, by making use of the heat produced, the efficiency of generator 600 can be enhanced.

When the depleted gas exits through the downstream end of fuel cell 671, it enters an afterburner 640 of base unit 601. Afterburner 640 completes any remaining combustion of gas flowing out of fuel cell 671, and converts it to carbon dioxide and water vapor. This exhaust gas exits through exhaust ports 641. As discussed above, preferred embodiments of the invention use a catalytic oxidizer, and no open flame, for afterburner 640. This helps avoid NOX emissions and reduces fuel slip, to help operate at or near 100% conversion. The solid-state nature of the reaction bed also helps with thermal transfer.

As described above, electricity generators in accordance with the invention can comprise a base unit having the fuel and air blower elements attached thereto, and an assembly of CPOX reaction tubes for converting reformable fuel and air mixtures into hydrogen rich reformate product to be sent into the central opening of fuel cells defined by the anode. The electricity generator can also include a releasably attachable fuel cell unit having an assembly of fuel cells coupled to an electricity collection structure for collecting the electricity produced by the fuel cells. The electricity collector is preferably thermally isolated from the heat produced by the fuel cells and CPOX reformers. For example, an end of the fuel cells can be blocked from receiving the hydrogen rich reformate. This inactive end will not produce heat. It is advantageous to extend this inactive end through the enclosure surrounding the fuel cell unit. An insulation layer can help keep the heat within the enclosure.

Each CPOX reaction tube can be associated with a corresponding fuel cell. When the base unit is plugged into the fuel cell unit, the reactor tubes are inserted into the central opening of the fuel cells, which then surround the CPOX reaction tubes. The upstream end of the fuel cells is at the distal end and the upstream end of the CPOX reaction tubes is at the proximal end. In this manner, the reformable fuel/air mixture can flow downstream through the CPOX reactor tubes as hydrogen is generated. As the hydrogen rich reformate reaches the downstream distal end of the CPOX tubes, it can be redirected in a fuel cell downstream proximal direction, back over the outside of the CPOX reactor tubes, along the anode the surrounding inner opening of the fuel cell tube. As the hydrogen rich reformate gas travels downstream through the fuel cell, it produces heat, steam and electricity. This electricity is collected by a current collection structure interconnecting the fuel cells.

In a preferred embodiment of the invention, a secondary fuel line either passes through the middle of the CPOX reactor tube, or around the outside of the CPOX reactor tube. This secondary fuel line sends a stream of secondary fuel into an active portion of the fuel cell at a position preferably just downstream from the outlet of the CPOX reactor tube. At this location, the fuel cell is converting the hydrogen from the reformate exiting the CPOX reactor tube into electricity, and making heat and steam. This heat and steam will steam reform the secondary fuel stream into additional hydrogen, without substantially increasing the overall dimensions of the electricity generating device. As the depleted gas stream exits the fuel cell, it can be passed through the afterburner, so that the only emissions are carbon dioxide and water vapor.

By mounting the fuel cells in a detachable unit, the fuel cells and current collector structure can be replaced in a simple manner, without having to replace the more robust and expensive structures on the base unit, which includes the CPOX reaction tubes and blowers. This easy to remove and replace unit can be part of routine maintenance and field servicing. The base unit can also include the monitoring components, such as the thermocouples for monitoring the temperature within the stack and the after-burner components. The ability to quickly and easily remove and replace the fuel cell unit can reduce maintenance and repair costs, as the fuel cell and current collection structures tend not to last as long as the blower units and CPOX reaction tubes of the base unit. The fuel cell unit can be detached from the base as a unit, slid off the CPOX reaction tubes, and replaced.

The CPOX reaction tubes and corresponding fuel cell tubes in accordance with the invention can be provided as an assembly of more than 4, 15, 24 or more CPOX reaction tube/fuel cell combinations. For example, they can be provided as a 2×4, 3×5, 3×8, 4×8 matrix, and so forth. The CPOX reaction tubes can be any size, but are advantageously shorter than about 14 inches long, preferably shorter than about 8 inches. They can have an outer diameter below about 0.4 inches, preferably below about 0.2 inches. The fuel cell tubes can be formed with any size, but are advantageously shorter than about 12 inches long, preferably shorter than about 8 inches. They can have an outer diameter below about 0.6 inches, preferably below about 0.4 inches.

The overall dimensions of the electricity generator, including blowers, reforming tubes, fuel cells and current collectors can be formed of any size, such as over about a cubic foot, but advantageously has a maximum dimension below about 30 inches, preferably below about 20 or 15 inches. Electricity generators in accordance with the invention can be formed with an overall volume greater than about one cubic foot. They can also be formed with overall volumes of less than about three or four cubic feet. The overall volume can take any size, but is advantageously below about 1 cubic foot, preferably below about 800 in³, more preferably below about 500 in³.

It can therefore be seen that the objects set forth above, among those made apparent from the preceding description and figures, are efficiently attained, and, since certain changes may be made in carrying out the above constructions and methods without departing from the spirit and scope of the invention, it is intended that all matter contained in the above description and shown in the accompanying drawings shall be interpreted as illustrative and not as limiting.

It is also to be understood that the following claims are intended to cover all of the generic and specific features of the invention herein described and all statements of the scope of the invention which, as a matter of language, might be said to fall therebetween.

1. An electricity generator, comprising:
a base housing comprising an array of reactor tubes having an inlet and an outlet and comprising CPOX catalyst, adapted to convert gaseous hydrocarbon fuel and oxygen containing gas into a hydrogen rich reformate;
a fuel cell housing comprising an array of fuel cell tubes each having an upstream region and a downstream outlet;
the base housing mated with the fuel cell housing and the array of reactor tubes extending into respective fuel cell tubes, and the outlet of the reactor tubes is positioned at the upstream region of the fuel cell tubes;
wherein the base housing is releasably coupled to the fuel cell housing to form an enclosure and the reactor tubes are removably extended into the fuel cell tubes within the enclosure.

2. (canceled)

3. The electricity generator of claim 2, and wherein a current collection structure system is mounted on the fuel cell housing, outside the enclosure, and electrically connects the array of fuel cells.

4. The electricity generator of claim 3, and wherein a blower system is mounted on the base housing, outside the enclosure and is adapted to blow fuel and oxygen containing gas to the reactor tubes and fuel cells.

5. An electricity generator, comprising:
a base unit having a base unit housing releasably coupled to a fuel cell unit having a fuel cell housing, the coupled base unit housing and fuel cell housing forming an enclosure;
the base unit housing surrounding at least one CPOX reactor tube having walls comprising a gas-permeable catalytic inner surface including CPOX catalytic material, the catalytic inner surface defining an interior of the CPOX reactor tube, and the base unit having a blower assembly having a blower outlet in fluid communication with the interior of the CPOX reactor tube the blower assembly adapted to supply a reformable gas stream mixture of an oxygen containing gas and a primary gaseous reformable fuel, the blower assembly adapted to supply the reformable gas mixture in a downstream direction through the interior of an upstream end of the CPOX reactor tube, toward a downstream end of the CPOX reactor tube, along the CPOX catalytic inner surface;
the fuel cell housing surrounding at least one fuel cell tube having a fuel cell wall with an inner surface anode layer defining a fuel cell interior and having an electrochemically active region adapted to generate electricity, heat and steam;
the fuel cell tube and CPOX reactor tube each sized and respectively positioned in the fuel cell unit and the base unit, such that when the base unit is coupled to the fuel cell unit, the CPOX reactor tube extends into the fuel cell tube with the downstream end of the CPOX reactor tube extending to an electrochemically active upstream end region of the fuel cell tube, with the fuel cell tube extending from the fuel cell upstream end region in a proximal direction opposite the distal direction over the CPOX reactor tube, the fuel cell and reactor tube adapted such that a reformate gas stream exiting the downstream end of the CPOX reactor tube will be directed by the construction of the upstream end region of the fuel cell tube in the proximal direction, toward a downstream end of the fuel cell tube, over the CPOX reactor tube;
whereby the CPOX reactor tube and fuel cell tubes are adapted so that as the gaseous reformable mixture flows through the CPOX reactor tubes, it will be catalytically converted into a hydrogen rich reformate, and as the hydrogen rich reformate flows through the electrochemically active region of the fuel cell tube, it will generate electricity, heat and steam.

6. The electricity generator of claim 5, wherein the fuel cell unit comprises a plurality of fuel cells and a current collection system electrically connecting the fuel cells, the current collection system located outside the enclosure.

7. The electricity generator of claim 6, wherein the upstream-most portion of the upstream end region of the fuel cell tube is an obstructed portion, such that the hydrogen rich reformate is blocked from contacting the inner surface of the fuel cell tubes at such upstream-most obstructed portion, whereby it will not generate electricity and heat at the obstructed portion, and the obstructed portion extends outside the enclosure.

8. The electricity generator of claim 7, wherein the obstructed portion contains copper doped thermal insulating material.

9. The electricity generator of claim 5, wherein the base unit housing and the fuel cell housing include structures to releasably lock the two housings together.

10. The electricity generator of claim 5, wherein a secondary fuel tube extends through the interior of the CPOX reactor tube or over and outside the CPOX reactor tube, the secondary fuel tube having a secondary gaseous reformable fuel inlet in fluid communication with the blower assembly, adapted to receive a secondary gaseous reformable fuel into an upstream end of the secondary fuel tube, and an outlet of the secondary fuel tube is positioned in the electrochemically active upstream end region of the fuel cell.

11. The electricity generator of claim 10, wherein the outlet of the CPOX reactor tube extends in the distal direction beyond the outlet of the secondary fuel tube.

12. The electricity generator of claim 10, wherein the CPOX reactor tube extends through the secondary fuel tube.

13. The electricity generator of claim 10, wherein the blower assembly is adapted to supply the reformable oxygen containing gas and primary gaseous reformable fuel mixture into the CPOX reactor tube.

14. The electricity generator of claim 13, wherein the blower assembly is adapted to supply an oxygen containing gas to the at least one fuel cell.

15. The electricity generator of claim 5, wherein the base unit housing comprises multiple CPOX reactor tubes and the fuel cell housing comprises multiple fuel cell tubes corresponding to each of the CPOX reactor tubes.

16. The electricity generator of claim 15, and comprising a current collection system located outside the enclosure, electrically coupled to each fuel cell tube, adapted to collect the current produced by the fuel cell tubes.

17. The electricity generator of claim 16, wherein the fuel cell tubes have the inner anode layer, an outer cathode layer, and an electrolyte layer therebetween, and the current collection system includes a cathode contact contoured to the shape of the cathode, electrically coupled to the cathode of each fuel cell, and an anode contact contoured to the shape of the anode, electrically coupled to the anode of each fuel cell, and each of the anode contacts and cathode contacts of the respective fuel cells are electrically coupled to each other.

18. The electricity generator of claim 5, and comprising an afterburner downstream from the at least one fuel cell, and the afterburner is configured to receive any gas exiting the fuel cell tube.

19. An electricity generator, comprising:
a base unit having a base housing, a blower assembly, and a plurality of CPOX reactor tubes, the CPOX reactor tubes having an upstream end and a downstream end and a hollow open bore gas passageway therethrough from the upstream end to the downstream end, with CPOX catalyst defining at least a portion of the open bore, the open bore and CPOX catalyst in fluid communication with the blower assembly;
a fuel cell unit having a fuel cell housing and a plurality of SOFC fuel cell tubes in the fuel cell housing, and having an electrochemically active fuel cell upstream end and downstream end within the fuel cell tubes;
the base unit releasably coupled to the fuel cell unit, with the base housing releasably coupled to the fuel cell housing to form an enclosure, and the CPOX reactor tubes extending into respective fuel cell tubes, with the downstream end of the CPOX reactor tubes within the electrochemically active upstream end of the fuel cell tube.

20. A method of generating electricity, comprising:
blowing a reformable gas mixture of a primary gaseous fuel and an oxygen containing gas in a distal direction through at least one CPOX reactor tube of a base unit and catalytically converting the fuel/oxygen mixture into a hydrogen rich reformate, the CPOX reactor tube mounted within a base unit housing releasably coupled to a fuel cell unit having at least one fuel cell mounted in a fuel cell housing, the base unit housing coupled to the fuel cell housing and forming an enclosure, the at least one CPOX reactor tube extending in the distal direction within the at least one fuel cell
directing the hydrogen rich reformate exiting the CPOX reactor tube into an upstream end of the fuel cell tube and flowing the reformate in the proximal direction, over the outside of the CPOX reactor tube, within the interior of the fuel cell and generating electricity, heat and steam.

21. The method of claim 20, wherein the base unit comprises a plurality of CPOX reactor tubes and the fuel cell unit comprises a plurality of fuel cell tubes positioned over the CPOX reactor tubes.

22. The method of claim 20, and comprising blowing a secondary fuel stream into an electrochemically active upstream end of the fuel cell tube, steam reforming the secondary fuel stream with the heat and steam generated by the fuel cell tube to form additional hydrogen and generating additional electricity by flowing the additional hydrogen downstream through the fuel cell tube.

23. The method of claim 20, and comprising blocking an endmost upstream end portion of the fuel cell tube from the hydrogen rich reformate and preventing the generation of electricity, heat and steam at this endmost upstream end portion.

24. The method of claim 23, and wherein the endmost portions are electrically connected and comprising collecting the electricity generated by the fuel cell tube with an electricity collector located at the end most portions.

25. The method of claim 20, and comprising performing maintenance or repair by removing the fuel cell unit from the base unit, replacing the fuel cell unit with a new fuel cell unit and mating the new fuel cell unit with the existing base unit.
